(19) United States
(12) Patent Application Publication
(10) Pub. No.: US 2006/0270345 A1
(43) Pub. Date: Nov. 30, 2006

(54) Wireless adapter

(76) Inventors: Robert W. DiGiovanna, Shirley, NY (US); Paul Orfin, Patchogue, NY (US)

Correspondence Address: FAY KAPLUN & MARCIN, LLP, 15O BROADWAY, SUITE 702, NEW YORK, NY, 10038, US

(21) Appl. No.: 11/142,687

(22) Filed: May 31, 2005

(51) Int. Cl. H04B 7/00

(52) U.S. Cl. 455/41.2

(57) ABSTRACT

Many devices, such as, for example, scanners, have been designed to couple to another device or a network through a wire. Wireless connectivity can be added to the device through an adapter that couples to the device's communication port. In addition, the device can draw power from the adapter. An exemplary adapter can be made to fit into an existing device, or future devices can be designed to accommodate wired and wireless connections.

### FIELD OF THE INVENTION

The invention is directed to electronic devices and, more particularly to an adapter for adding wireless capabilities to a wired device.

### BACKGROUND OF THE INVENTION

Different devices are often coupled together as peripherals and/or nodes for communication, expansion of functionality, ease of use, etc. For example, a barcode scanner can be coupled to a point of sale (POS) terminal to allow the terminal to quickly retrieve information related to the scanned product. Or a plurality of computers can be coupled together to form a communication network, such as for example the Internet.

Many of the devices have been designed to coupled together using a wire. Information and/or power can be transferred through the connection. As wireless technology continues to grow, people and companies will want to implement wireless solutions to help their lives and businesses.

Unfortunately, people and companies have invested considerable amounts of money purchasing wired versions of devices. Additionally, designing cordless versions of corded devices device requires large amounts of man-power and capital. For example new circuit boards would have to be designed, regulatory testing may be required and even new plastics may have to be created.

Accordingly, there is a desire for methods and apparatus for adding wireless communications to a wired device. In addition, there is a desire for products that can be used in either a wired configuration or a wireless configuration so that the customer can decide which means of connectivity is most suitable to them.

### SUMMARY OF THE INVENTION

The invention as described and claimed herein satisfies this and other needs, which will be apparent from the teachings herein. An embodiment of the invention includes methods and apparatus for cordless communication with corded machines.

An exemplary wireless adapter comprises a communication module, an antenna and a power source. The communication module comprises a connecting module for coupling the adapter to a device. The connecting module can be used for communicating information and/or power between the device and the adapter. For example the connecting module can be a universal serial bus (USB) connector. In alternate embodiments, the scanner can have a connecting module for information and a separate connecting module for power.

The wireless adapter receives information from the device, and wirelessly communicates with a second device. Some exemplary wireless communication standards comprise Bluetooth™, Zigbee™ and 802.11. In some embodiments, the wireless adapter can also wirelessly receive information from the second device and can relay that information to the first device. The first device does not have to know that the information was transmitted wirelessly.

The wireless adapter is securely attached to the device through a securing connecting module. The securing connecting module can be a clip, a screw, a lock, etc.

In one exemplary embodiment of the invention, the wireless adapter can be used to add cordless connectively to existing corded barcode scanners. The scanners can use the adapter to wirelessly communicate with a terminal, a server, another scanner, etc. The scanner can be part of an enterprise mobility network, used to conduct business.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates and exemplary asset management network implemented according to an embodiment of the invention.

FIG. 2 illustrates and exemplary device and a wireless adapter implemented according to an embodiment of the invention.

FIG. 3 illustrates an exemplary scanner implemented according to an embodiment of the invention.

FIG. 4 illustrates an exemplary wireless adapter implemented according to an embodiment of the invention.

FIG. 5 illustrates the wireless adapter of FIG. 4 coupled to the device of FIG. 5.

FIG. 6 illustrates an exemplary method of wireless communication implemented according to an embodiment of the invention.

### DETAILED DESCRIPTION OF EXEMPLARY EMBODIMENTS

There will now be shown and described in connection with the attached drawing figures several exemplary embodiments of methods and apparatus for a wireless adapter.

Replacing corded devices with wireless device is an expensive and time consuming task. Therefore, an exemplary embodiment of the invention provides a wireless adapter that plugs into an existing corded product. The adapter comprises a wireless communication module, such as, for example, a radio, and a power source, such as, for example, a battery. A wireless adapter can save money in replacement costs by expanding the functionality of existing products, and it can save money in development costs by reducing design cycle time for new products through design reuse.

The converted device communicates with the wireless adapter as if it was coupled to a wire. Then, the wireless adapter transmits the information to the machine that the original device would normally be attached to. Since the converted device is kept ignorant of the wireless connection, software in the device does not have to be modified.

Depending on the wireless protocol used and/or the type of the machine, the wireless adapter coupled to the device may require a complementary adapter that couples to the machine. The complementary adapter receives the information from the device and transmits the information to the machine as if the device was coupled to the machine through a wire. The complementary adapter can be, in some embodiments, implemented as part of a base. The base can be, for example a recharging cradle for the wireless adapter. Therefore, the wireless adapter can recharge through the machine.

In some embodiments, the corded device may already have its own power source. In those embodiments, the wireless adapter can shut off its power source, or the device user can use a wireless adapter that does not include a power source. In addition, a device designed with a wireless adapter in mind may also comprise some or all of the wireless communication hardware and software. In this embodiment, the wireless adapter is used mainly for its antenna when communicating.

In embodiments of the invention, the machine may comprises a wireless receiver that can wirelessly connect to a plurality of devices. In these embodiments, a complementary adapter would not be required. For example, a proprietary wireless protocol may require a complementary adapter, but a POS terminal that is Bluetooth™ enabled can connect to a scanner comprising a Bluetooth™ enabled wireless adapter without a complementary adapter.

A wireless adapter, implemented in accordance with an embodiment of the invention, can be used to wirelessly couple a corded device to another machine. In some embodiments, the machine is coupled to a communication network. In other embodiments, a wireless adapter can be used to wirelessly couple a corded device directly to a communication network.

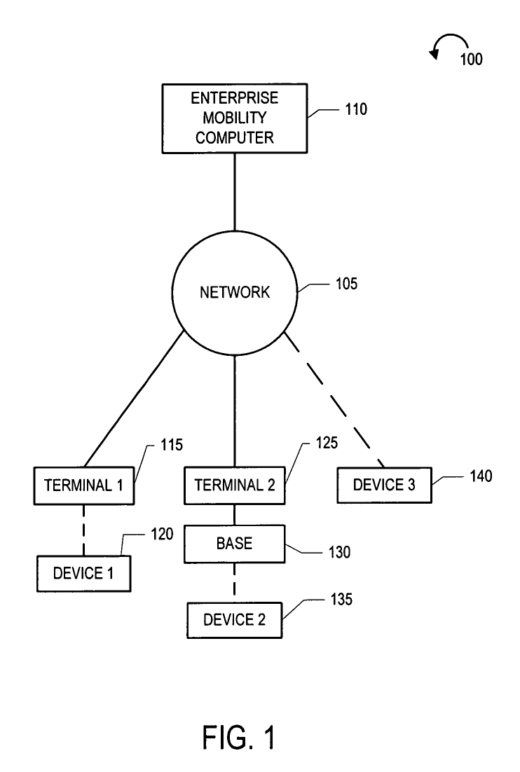

FIG. 1 illustrates an exemplary communication network 100 comprising a network 105. Network 105 can be an internet, an intranet, the Internet, and any other communication network or combination of networks. Therefore, the communication network 100 can comprise a proprietary network 105, or the communication network 100 can operate over an existing network 105, such as, the Internet. In other embodiments the communication network 100 is made of a combination of private, public and general networks.

An enterprise mobility network 100 is an example of a communication network 100. An enterprise mobility network allows companies to mange inventory and service customers. The enterprise mobility network comprises data capture devices, such as, for example, a barcode scanner, and terminals, such as for example, a POS terminal. It can also comprise servers, mobile computers, mobile terminals, personal digital assistants (PDAs), routers, etc. Inventory information, such as for example, quantities and price can be stored, in an embodiment, at an enterprise mobility computer 110. The information can be sent over the network 105 to a terminal and/or some other device.

Enterprise mobility network 100 comprises device one 120, for example, a scanner 120, coupled to terminal one 115, for example a point of sale (POS) terminal 115. Terminal one 115 is coupled to the network 105. Dotted lines represent wireless couplings and solid lines represent wired couplings. Therefore, device one 120 is wirelessly coupled to terminal one 115, and terminal one 115 is wired to the network 105. The wired and wireless couplings in this network 100 are exemplary. For example, in other embodiments, devices may couple to a terminal through a wire, and terminal one 115 can couple to the network 105 wirelessly.

Device one 120 comprises a wireless adapter that allows it to wirelessly communicate with terminal one 115. As mentioned above, depending on the wireless protocol used and/or the type of the terminal, terminal one 115 may comprise a complementary adapter to communicate with device one 120. Device one 120 can be configured to communicate in a RS-232 mode, a USB mode, etc.

Device two 135 is wirelessly coupled to a base 130. Device two 135 can be a converted corded scanner, and the base 130 can be a charging/communication cradle. The base 130 is coupled to terminal two 125, and terminal two 125, is coupled to the network 105. In alternative embodiments of the invention, base 130 may or may not include a complementary adapter.

Device three 140 is directly coupled to the network 105. Device three 140 can be a mobile computer, a mobile terminal, etc. Although, three devices 120, 135, 140 are shown in FIG. 1, in alternate embodiments of the invention, a plurality of devices, terminals, peripherals, etc, can be coupled to the network 105.

An enterprise mobility computer 110 is also coupled to the network 105. enterprise mobility computer 110 comprises methods that are used to manage the assets in the enterprise mobility network 100. While enterprise mobility network 100 appears to have a client/server configuration, in alternate embodiments of the invention the enterprise mobility network 100 can be configured as a peer to peer network. For example, certain, more powerful devices, such as, for example, a mobile computer, can act as “super peers” to simpler devices, such as for example, a handheld scanner.

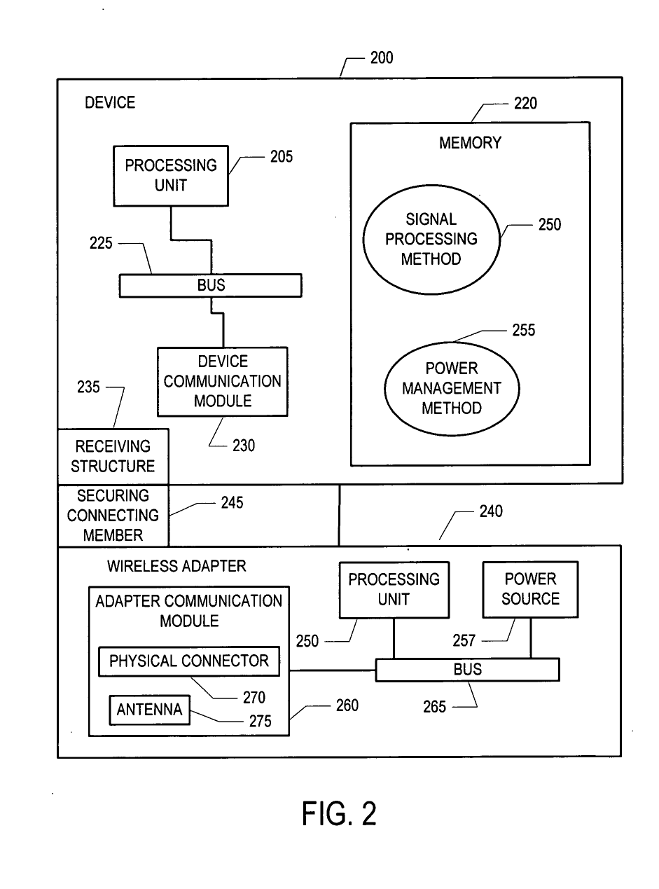

FIG. 2 illustrates an exemplary device 200, which can be implemented as, in various embodiments, devices one, two and three 120, 135, 140 of FIG. 1. In addition, FIG. 2 illustrates an exemplary wireless adapter 240, implemented in accordance with an embodiment of the invention.

The device 200 can be, in exemplary embodiments, a handheld scanner, mobile computer, a desktop, a terminal, etc. The computer 200 comprises a processing unit 205, a device communication module 230 and memory 220 coupled together by bus 225. The modules of device 200 can be implemented as any combination of software, hardware, hardware emulating software, and reprogrammable hardware. The bus 225 is an exemplary bus showing the interoperability of the different modules of the asset management computer 200. As a matter of design choice there may be more than one bus, and in some embodiments certain modules may be directly coupled instead of coupled to a bus 225. Additionally, some modules may be combined with others.

Processing unit 205 can be implemented as, in exemplary embodiments, one or more Central Processing Units (CPU), Field-Programmable Gate Arrays (FPGA), etc. In an embodiment, the processing unit 205 can comprise a general purpose CPU. In other embodiments, modules of the processing unit 205 may be preprogrammed or hardwired, in the processing unit's 205 memory, to perform specific functions. In alternate embodiments, one or more modules of processing unit 205 can be implemented as an FPGA that can be loaded with different processes, for example, from memory 220, and perform a plurality of functions. Processing unit 205 can comprise any combination of the processors described above.

Device communication module 230 comprises one or more input/output interfaces used by the computer 200 to communicate with users, other devices, etc. An interface is any structure, device, module, etc. that facilitates the communication of one system with another system. A system can be a human or a computer. Interfaces can include a modem, a network interface card (NIC), a monitor, a keyboard, a keypad, a mouse, a voice recognizer, a port for a wire, and any other I/O device. In one embodiment of the invention, the device 200 receives power and information from the same communication interface, such as, for example, USB or an Ethernet interface. In other embodiments, a communication interface of device communication module 230 can be dedicated to transmitting information. A separate interface is used to obtain power, or power can be obtained from an internal power source.

Memory 220 can be implemented as volatile memory, non-volatile memory and rewriteable memory, such as, for example, Random Access Memory (RAM), Read Only Memory (ROM) and/or flash memory. Memory 220 is illustrated as a single module in FIG. 2, but in some embodiments, memory 220 can comprise more than one memory module and some memory 220 can be part of other modules of the device 200, such as, for example, processing unit 205.

Different devices perform different functions, thus different devices store different methods in memory. An exemplary device, such as, for example, a handheld scanner, can comprise a signal processing method 250 and a power management method 255. The scanner can be a laser scanner, imaging scanner, etc.

Power management method 255 manages the power used by a device 200. In some embodiments, the device 200 can switch to a power save mode, when no activity is detected for a given amount of time. The power save mode can completely shut down the device 200 or alternatively, it can slow down device operations, or initiate other power saving techniques.

In a scanner, when a decoding operation is initiated, for example, a trigger is pressed, the scanner reads a target dataform, for example, a barcode, and analyzes the dataform. Signal processing method 250 is used by the scanner to decode dataforms.

The decoded signal can be used to obtain information specifically related to a product identified by the dataform. For example, quantity information and price information. This information can be stored on a node in the network 105, for example the enterprise mobility computer 110.

In an exemplary data capture method, the scanner 200 transmits the decoded information out on its communication interface 230 to wireless adapter 240 as if it were coupled to a wire. The wireless adapter 240 wirelessly communicates the barcode information to a POS terminal 115. The POS terminal 115 communicates with an enterprise mobility computer 110, for example, through a network 105, and obtains product information. The information can then be used to checkout a customer.

The exemplary embodiment of FIG. 2 illustrates signal processing method 250 and power management method 255 as separate components, but these methods are not limited to this configuration. Each method and database, described herein, in whole or in part can be separate components or can interoperate and share operations. Additionally, although the methods are depicted in the memory 220, in alternate embodiments the methods can be incorporated permanently or dynamically in the memory of processing unit 205.

FIG. 2 also illustrates an exemplary wireless adapter 240 implemented in accordance with an embodiment of the invention. The wireless adapter 240 comprises a processing unit 250, an adapter communication module 260 and a power source 257 coupled together by bus 265. As with the device 200, the bus 265 of the wireless adapter 240 illustrates the interoperability of the modules of wireless adapter 240. In other embodiments, some modules of the wireless adapter 240 may be directly coupled together and/or incorporated within one another. The processing unit 250 can be similar to the processing unit of device 200. Wireless adapter 240, can also comprise memory (not shown), for storing information.

Adapter communication module 260 comprises physical connector 270 and antenna 275. Physical connector 270 is a connecting module that couples to the communication interface 230 of device 200. Information and/or power can be transferred through the physical connector 270. In some embodiments, the wireless adapter 240 may comprise two physical connecters, one for information and the other for power. The wireless adapter 240 uses the antenna 275 to wirelessly communicate with a base, a terminal, another device, a network, a server, etc.

Power source 257, can be implemented as a rechargeable battery. Some wireless adapters may not comprise a power source 257, for example, if the device 200 has an alternate power source. The wireless adapter 240 can also comprise contacts (not shown), through which the power source can be recharged.

In some embodiments of the invention, the wireless adapter 240 can comprise a securing connection member 245. The securing connecting member 245 couples securely with receiving structure 235 in device 200. The securing connecting member 245 can be a clip, a rubber lining, a screw, etc. A secure connection between the device 200 and the adapter 240 improves performance quality and can be helpful to drop survivability of the device 200 and the adapter 240. In some embodiments, the receiving structure 235 can be part of the design of the device 200, such as an ornamental lip or bulge, and the wireless adapter 240 can have a securing connecting member 245 that attaches to that design feature.

In some embodiments, the securing connecting member 245 is part of the physical connector 270 and the receiving structure 235 is part of the communication interface 230. For example a CAT-5 cable has a plug with a clip that securely attaches the cable to a port, when the plug enters the port.

The device 200 and/or the wireless adapter 240 can also comprise a release button (not shown). The release button, when pressed, unlocks the adapter 240 from the device 200.

A wireless adapter 240 can be designed to try and be compatible with as many existing corded devices a possible, or it can be designed to modify a particular corded device. For example a wireless adapter 240 may have more than one type of physical connector and/or a power source that can be turned on and off. Future corded products can be designed with a wireless adapter 240 in mind. Therefore, those devices can easily add wireless functionality using a standardize wireless adapter.

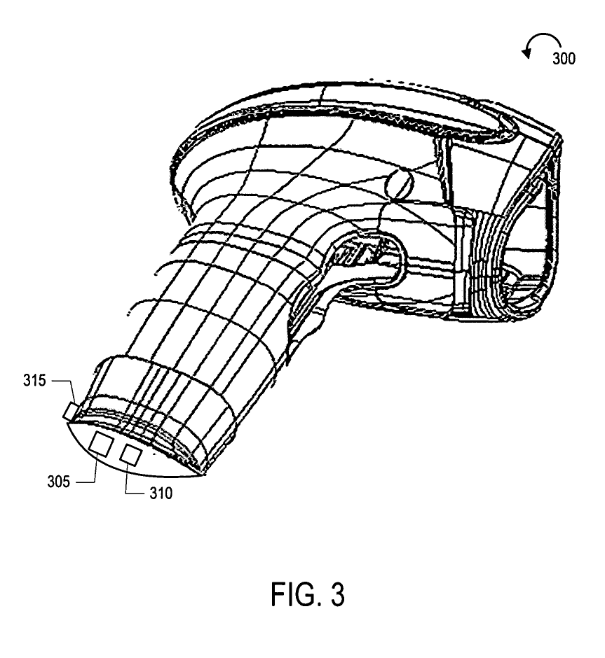

FIG. 3 illustrates an exemplary scanner 300, implemented in accordance with an embodiment of the invention. Scanner 300 comprises a receiving structure 305 and a device communication interface 310. Device communication interface 310 can receive a cord or a wireless adapter. Therefore, a scanner 300 user can decide which interface work best for them. Receiving structure 305 is used to accept a securing member from another part. This receiving structure 305 can work in conjunction with a release mechanism 315 to aid or allow for the connecting item to be removed. The release mechanism 315 need not be located on the scanner 300.

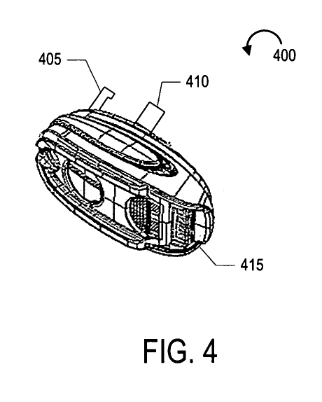

FIG. 4 illustrates an exemplary wireless adapter 400, implemented in accordance with an embodiment of the invention. Wireless adapter 400 comprises contacts 415, a securing connection member 405 and a connecting module 410. An example of a connecting module 410 is a physical connector 410. Contacts 415 can be used to recharge the battery and/or communicate with a base. Securing connection member 405 can have an integrated release mechanism (not shown).

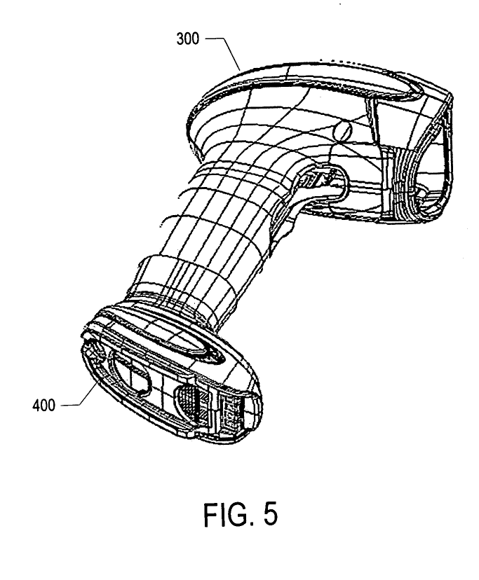

FIG. 5 illustrates the wireless adapter 400 coupled to the scanner 300. The securing connection member 405 enters receiving structure 305 and couples the adapter 400 securely to the scanner 300. Physical connector 410 enters device communication interface 310, and the device 300 uses the interface to communicate with the wireless adapter 400, and to obtain power from the wireless adapter 400. A complementary base can also be made for the combined scanner and adapter. When the scanner/adapter is placed in the base, the contacts 415 connect with to contacts on the base and the adapter begins to recharge. In exemplary embodiments the adapter 400 and/or the scanner 300 can also communicate with other machines through the connection between the contacts.

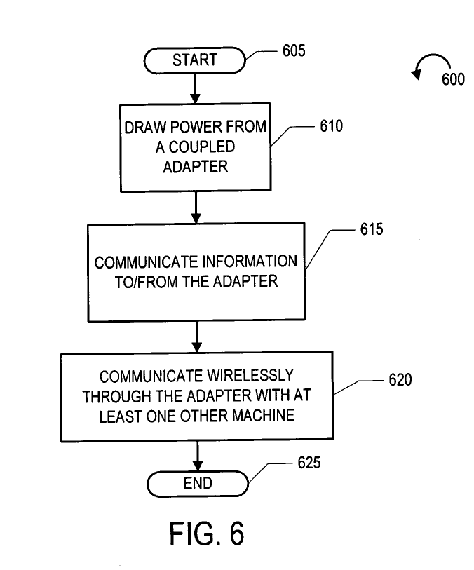

FIG. 6 illustrates an exemplary wireless communication method 600, implemented in accordance with an embodiment of the invention. Method 600 starts in step 605, for example, with an adapter 240 connecting to a device 200. Following step 605, in step 610, the device 200 draws power from the coupled adapter 240.

Following step 610, method 600 proceeds to step 615 where the device 200 communicates with the adapter 240. The device does not have to know that it is coupled to a wireless adapter. The device can transmit and receive information and/or power as if it were connected to another machine through a wire. Method 600 then proceeds to step 620, where the device 200 communicates wirelessly with at least one other machine through the adapter 240. Method 600 ends in step 625, for example, with the scanner powering down, and/or with the separation of the wireless adapter 240 from the device 200.

The order of the steps of the methods described herein are exemplary and the order of the steps may be rearranged. In addition, some steps may be omitted and/or other steps added in alternate embodiments of the invention.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. An adapter comprising:
a communication module comprising,
a connecting module for coupling said adapter to a device, wherein said connecting module can be used for communicating information between said device and said adapter, and wherein said adapter communicates wirelessly with a second device,
an antenna; and
a power source, wherein said connecting module can be used for transmitting power to said device.

2. The adapter of claim 1, wherein said adapter communicates in at least one of a Bluetooth™ standard, a Zigbee™ standard and an 802.11 standard.

3. The adapter of claim 1, wherein communication between said device and said adapter is in at least one of RS-232 and USB.

4. The adapter of claim 1, wherein said connecting module further comprises a securing structure connecting said adapter to said device.

5. The adapter of claim 1, wherein said connecting module is one of a connecting member and a receiving structure.

6. The adapter of claim 1, wherein said device comprises a dataform capture module.

7. The adapter of claim 1, wherein said second device is one of a host on a network, a computer, a charging base and a terminal.

8. The adapter of claim 1, wherein said communication module comprises a first connecting module for transmitting power and a second connecting module for communicating information.

9. The adapter of claim 1, further comprising a securing connecting module for securing said adapter to said device.

10. The adapter of claim 9, further comprising a switch for releasing said adapter from said device.

11. The adapter of claim 9, wherein said securing connecting module couples to ornamental designs on a device.

12. A device modified to communicate wirelessly comprising:
a device comprising a dataform scanning module; and
an adapter comprising:
a communication module comprising,
a connecting module for coupling said adapter to a device, wherein said connecting module can be used for communicating information between said device and said adapter, and wherein said adapter communicates wirelessly with a second device, and
an antenna.

13. The device of claim 12, further comprising a power source, wherein said connecting module can be used for transmitting power to said device.

14. The device of claim 12, wherein said connecting module further comprises a securing structure connecting said adapter to said device.

15. The device of claim 12, wherein said communication module comprises a first connecting module for transmitting power and a second connecting module for communicating information.

16. The device of claim 12, further comprising a securing connecting module for securing said adapter to said device.

17. The device of claim 16, further comprising a mechanism for releasing said adapter from said device.

18. The device of claim 16, further comprising a housing, said securing connecting module coupling to said housing.

19. A method of wireless communication comprising:
communicating with a coupled adapter said adapter comprising:
a communication module comprising,
a connecting module for coupling said adapter to a device, wherein said connecting module can be used for communicating information between said device and said adapter, and wherein said adapter communicates wirelessly with a second device, and
an antenna;
drawing power from said power source, wherein said connecting module can be used for transmitting power to said device.

20. The method of claim 20, further comprising, communicating with a wireless network through said adapter.
